(19) United States
(12) Patent Application Publication
(10) Pub. No.: US 2010/0315757 A1
(43) Pub. Date: Dec. 16, 2010

(54) ELECTRICAL COMPONENT

(75) Inventor: Hiroaki Yamazaki, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/714,764

(22) Filed: Mar. 1, 2010

(30) Foreign Application Priority Data
Jun. 11, 2009 (JP) 2009-139940

(51) Int. Cl. H01G 5/16

(52) U.S. Cl. 361/290

(57) ABSTRACT

An electrical component capable of performing hot switching at low power consumption is disclosed. The electrical component has a first electrical component and a second electrical component connected in parallel to the first electrical component. The first electrical component includes a first electrode and a second electrode facing the first electrode with a space in between, the second electrode is moved by a first actuator portion. The second electrical component includes a third electrode and a fourth electrode facing the third electrode with a space in between, the fourth electrode is moved by a second actuator portion having a stiffness higher than a stiffness of the first actuator portion, the second electrical component has an impedance becoming higher or lower than an impedance of the first electrical component depending on a moving state of the fourth electrode.

### CROSS REFERENCE TO RELATED APPLICATION

This application is based upon and claims the benefit of priority from the prior Japanese Patent Application No. 2009-139940, filed on Jun. 11, 2009, the entire contents of which are incorporated herein by reference.

### BACKGROUND

Elements, e.g., variable capacitors formed by using the micro electro mechanical systems (MEMS) technology have advantages such as a large variable ratio, a small deformation, and a large Q-value. Having such advantages, the variable capacitors are effective to be used in antenna matching circuits of portable devices.

A MEMS variable capacitor conventionally includes a first electrode formed on a substrate and a second electrode which is driven by an actuator. The MEMS variable capacitor obtains a large variable ratio by bringing the first electrode and the second electrode into close contact with each other with an insulating film in between, the insulating film formed on a surface of one of the first electrode and the second electrode.

Japanese Patent Application Publication No. 2006-32680 discloses a MEMS variable capacitor that includes a first electrode positioned at a lower portion of a cavity, a movable portion positioned inside the cavity, and a second electrode connected with the movable portion. The first electrode and the second electrode come into close contact with each other with an insulating layer, which functions as the movable portion, in between.

However, the MEMS variable capacitor disclosed in Japanese Patent Application Publication No. 2006-32680 has the following problem when performing a so-called hot switching in which the first electrode and the second electrode come into close contact with each other, and are then spaced apart from each other in a state where high frequency signals are passing through the MEMS variable capacitor. Specifically, in the hot switching, an operational defect may occur in which the first electrode and the second electrode are not spaced apart from each other (self-holding) due to effective electrostatic attraction caused by the high frequency signals.

For this reason, a minimum voltage required to maintain the close contact of the first electrode and the second electrode (a pull-out voltage) has to be set higher than a DC bias voltage equivalent to the effective electrostatic attraction.

As a result, a minimum voltage required to cause the first and second electrodes spaced apart from each other to come into close contact with each other (a pull-in voltage) becomes also higher. Thus, there is a problem that the power consumption of a drive circuit to drive an actuator is increased.

Furthermore, when the pull-in voltage becomes higher, it is also required to increase an applied voltage required to drive the capacitor. As a result, there is a problem that charging to the insulating film is increased and a reliability of the MEMS variable capacitor is decreased.

### SUMMARY

An electrical component of an aspect of the invention includes: a first electrical component including a first electrode and a second electrode facing the first electrode with a space in between, the second electrode being moved by a first actuator portion; and a second electrical component being connected in parallel to the first electrical component and including a third electrode and a fourth electrode facing the third electrode with a space in between, the fourth electrode being moved by a second actuator portion having a stiffness higher than a stiffness of the first actuator portion, the second electrical component having an impedance becoming higher or lower than an impedance of the first electrical component depending on a moving state of the fourth electrode.

### BRIEF DESCRIPTION OF THE DRAWINGS

FIG. 1 is a plan view showing an electrical component according to a first embodiment of the invention.

FIG. 2 is a cross-sectional view showing a first electrical component of the electrical component according to the first embodiment of the invention.

FIGS. 3A and 3B are views each showing a second electrical component of the electrical component according to the first embodiment of the invention. FIG. 3A is a cross-sectional view taken along the A-A line of FIG. 1 as seen in a direction of an arrow. FIG. 3B is a cross-sectional view taken along the B-B line of FIG. 1 as seen in a direction of an arrow.

FIGS. 4A and 4B are views each showing an equivalent circuit of the electrical component according to the first embodiment of the invention. FIG. 4A is an equivalent circuit when the second electrical component is in an off-state. FIG. 4B is an equivalent circuit when the second electrical component is in an on-state.

FIGS. 5A and 5B are graphs each illustrating an operational characteristic of the electrical component according to the first embodiment of the invention. FIG. 5A is a graph showing the operational characteristic of the first electrical component. FIG. 5B is a graph showing the operational characteristic of the second electrical component.

FIGS. 6A and 6B are views each illustrating the stiffness of the electrical component according to the first embodiment of the invention. FIG. 6A is a plan view showing the first electrical component. FIG. 6B is a plan view showing the second electrical component.

FIG. 7 is a timing chart showing the operation of the electrical component according to the first embodiment of the invention.

FIGS. 8A and 8B are views each showing an equivalent circuit of another electrical component according to the first embodiment of the invention. FIG. 8A is an equivalent circuit when the second electrical component is in the off-state. FIG. 8B is an equivalent circuit when the second electrical component is in the on-state.

FIG. 9 is a plan view showing an electrical component according to a second embodiment of the invention.

FIG. 10 is a view showing the electrical component according to the second embodiment of the invention and is a cross-sectional view taken along the C-C line of FIG. 9 as seen in a direction of an arrow.

FIGS. 11A and 11B are views each showing an equivalent circuit of the electrical component according to the second embodiment of the invention. FIG. 11A is an equivalent circuit when the second electrical component is in an off-state. FIG. 11B is an equivalent circuit when the second electrical component is in an on-state.

### DETAILED DESCRIPTION

Hereinafter, embodiments of the invention will be described with reference to the drawings.

### First Embodiment

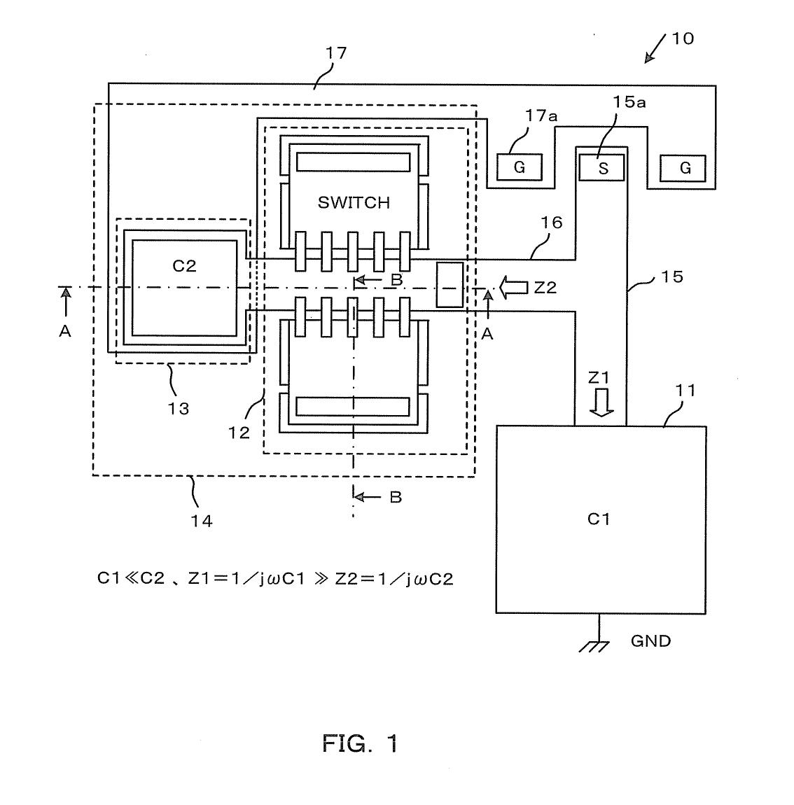

An electrical component according to a first embodiment of the invention will be described with reference to FIGS. 1 to 7.

As shown in FIG. 1, an electrical component 10 of the embodiment includes an electrostatically-driven variable capacitor (a first electrical component) 11 formed by using the MEMS technology and a series circuit (a second electrical component) 14 which is connected in parallel to the variable capacitor 11 and includes an electrostatically-driven switch 12 formed by using the MEMS technology and a capacitor 13 in series.

The variable capacitor 11 is connected to an external high frequency circuit (unillustrated) through a wiring 15 having an input pad 15a formed at one end.

The switch 12 of the series circuit 14 is connected to the variable capacitor 11 through a wiring 16 branching off from the wiring 15. The capacitor 13 is grounded through a wiring 17 having a ground pad 17a formed at one end.

When the switch 12 is in an off-state, a capacity C2 of the capacitor 13 is disconnected from a capacity C1 of the variable capacitor 11. When the switch 12 is in an on-state, the capacity C2 of the capacitor 13 is connected in parallel to the capacity C1 of the variable capacitor 11.

An impedance Z2 of the series circuit 14 with respect to the high frequency signal has a relation of Z2=1/jωC2 and is set to be sufficiently smaller than an impedance Z1 of the variable capacitor 11 which has a relation of Z1=1/jωC1 (Z2<<Z1). In other words, the capacity C2 is set so as to be sufficiently larger than the capacity C1 (C1<<C2).

Accordingly, the series circuit 14 can function as a shunt circuit which allows the high frequency signal to bypass the variable capacitor 11. Hereinafter, the series circuit 14 and the switch 12 are also respectively referred to as the shunt circuit 14 and the shunt switch 12.

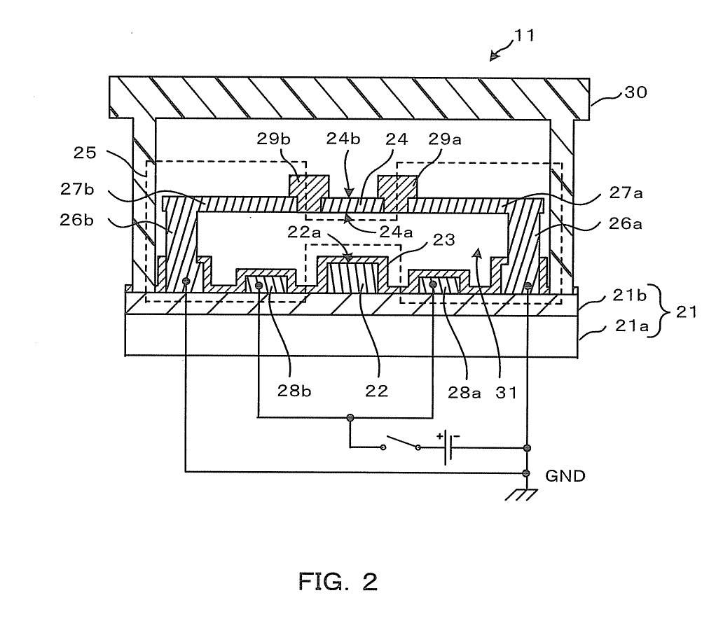

FIG. 2 is a cross-sectional view showing the variable capacitor 11 of the electrical component 10. As shown in FIG. 2, the variable capacitor 11 includes a first electrode 22 and a second electrode 24. The first electrode 22 is formed on a main surface of a substrate 21, and has a first surface 22a on the opposite side of the surface facing the substrate 21, the first surface 22a being covered with an insulating film 23. The second electrode 24 has a first surface 24a facing the first surface 22a of the first electrode 22 with a space in between and is driven by a first actuator portion to be described later.

The first actuator portion 25 includes a pair of conductive leg portions 26a, 26b (first leg portions), a pair of conductive arm portions 27a, 27b (first arm portions), and a pair of drive electrodes 28a, 28b (first drive electrodes). The leg portions 26a, 26b are disposed on both sides of the first electrode 22 so as to be spaced apart from each other and are set upright from the main surface of the substrate 21. The arm portions 27a, 27b extend from upper ends of the pair of the leg portions 26a, 26b, respectively, in a direction parallel with the substrate 21 and have tip ends facing each other with a space in between. The drive electrodes 28a, 28b are formed on the main surface of the substrate 21 at positions between the first electrode 22 and the pair of the leg portions 26a, 26b, respectively.

The second electrode 24 is connected to the tip ends of the pair of the arm portions 27a, 27b facing each other while having insulating materials 29a, 29b interposed between the second electrode 24 and the arm portions 27a, 27b, respectively. The insulating materials 29a, 29b are joints to connect the second electrode 24 to the tip ends of the arm portions 27a, 27b.

The substrate 21 includes a silicon substrate 21a and a silicon oxide film 21b formed on the silicon substrate 21a, for example.

The first electrode 22, the second electrode 24, the leg portions 26a, 26b, the arm portions 27a, 27b, and the drive electrodes 28a, 28b are formed of an aluminum material, for example.

The insulating film 23 is also formed on the main surface of the substrate 21, on both side surfaces of the first electrode 22, top and both side surfaces of the drive electrodes 28a, 28b, both side surfaces and lower portions of the leg portions 26a, 26b.

When the second electrode 24 is in close contact with the first electrode 22 by being driven by the first actuator portion 25, the first electrode 22 and the second electrode 24 become connected through a capacity formed of the insulating film 23. Accordingly, it is preferable that the insulating film 23 be formed of an insulating film material with a large dielectric constant, such as a silicon nitride (SiN), an aluminum oxide film (Al₂O₃), an aluminum nitride (AlN), or a tantalum oxide film (Ta₂O₃).

To protect the first actuator portion 25 from the outside and secure an operation space for the first actuator portion 25, a cap body 30 having a recessed portion is fixed to the substrate 21 through an adhesion layer (unillustrated) so that a cavity 31 is formed.

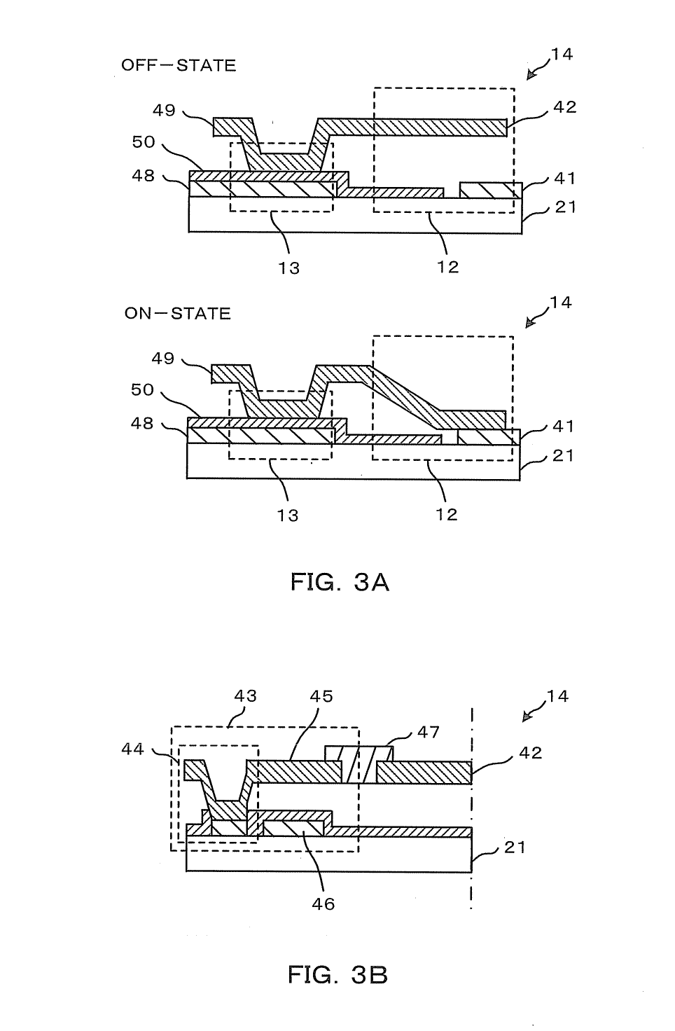

FIGS. 3A and 3B are views each showing the second electrical component 14. Specifically, FIG. 3A is a cross-sectional view taken along the A-A line of FIG. 1 as seen in a direction of an arrow. FIG. 3B is a cross-sectional view taken along the B-B line of FIG. 1 as seen in a direction of an arrow.

As shown in FIGS. 3A and 3B, the shunt switch 12 of the shunt circuit 14 includes a third electrode 41 formed on the main surface of the substrate 21 and a fourth electrode 42 which faces the third electrode 41 with a space in between and is driven by a second actuator portion 43 whose stiffness is higher than that of the first actuator portion 25.

The second actuator portion 43 includes a pair of conductive leg portions 44 (second leg portions), a pair of conductive arm portions 45 (second arm portions), and a pair of drive electrodes 46 (second drive electrodes). The leg portions 44 are disposed on both sides of the third electrode 41 so as to be spaced apart from each other and are set upright from the main surface of the substrate 21. The arm portions 45 extend from upper ends of the pair of the leg portions 44, respectively, in a direction parallel with the substrate 21 and have tip ends facing each other with a space in between. The drive electrodes 46 (second drive electrodes) are formed on the main surface of the substrate 21 in positions between the third electrode 41 and the pair of the leg portions 44, respectively.

The fourth electrode 42 is connected to the tip ends of the pair of the arm portions 45 facing each other with insulating materials 47 interposed between the fourth electrode 42 and the arm portions 45, respectively. The insulating materials 47 are joints to connect the fourth electrode 42 to the tip ends of the arm portions 45.

The capacitor 13 is a metal insulator metal (MIM) capacitor which is formed by holding an insulating film 50 between a lower electrode 48 and an upper electrode 49. The lower electrode 48 continues to the wiring 17 and is grounded. The upper electrode 49 continues to the fourth electrode 42. Similar to the insulating film 23, it is preferable that the insulating film 50 be formed of an insulating film material having a large dielectric constant.

In order to make the capacity C2 sufficiently larger than the capacity C1, an area of the capacitor 13 in which the lower electrode 48 and the upper electrode 49 are in close contact with each other with the insulating film 50 in between is set to be sufficiently larger than an area of the variable capacitor 11 in which the first electrode 22 and the second electrode 24 are in close contact with each other with the insulating film 23 in between.

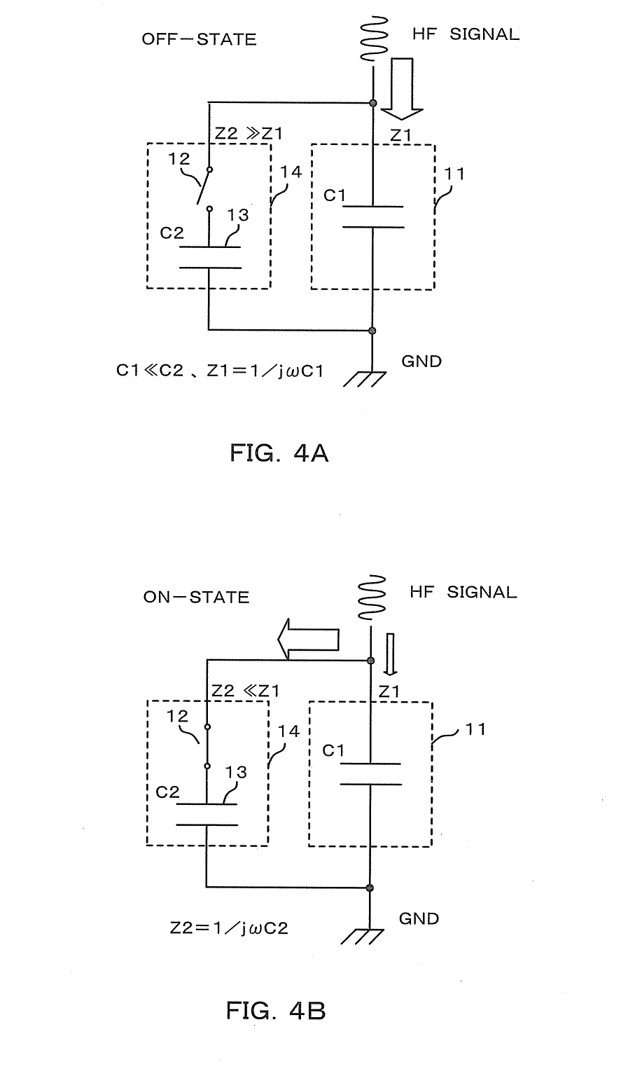

FIGS. 4A and 4B are equivalent circuits of the electrical component 10. Specifically, FIG. 4A is an equivalent circuit when the second electrical component 14 is in the off-state. FIG. 4B is an equivalent circuit when the second electrical component 14 is in the on-state. Note that the variable capacitor 11 (the capacity C1) is in the on-state here.

As shown in FIG. 4A, when the shunt switch 12 is in the off-state, the impedance Z2 of the shunt circuit 14 shows a value sufficiently larger than the impedance Z1 of the variable capacitor 11. Thus, the high frequency signal passes through the variable capacitor 11.

On the other hand, as shown in FIG. 4B, when the shunt switch 12 is in the on-state, the impedance Z2 of the shunt circuit 14 shows a value sufficiently lower than the impedance Z1 of the variable capacitor 11. Thus, the high frequency signal is bypassed to the shunt circuit 14.

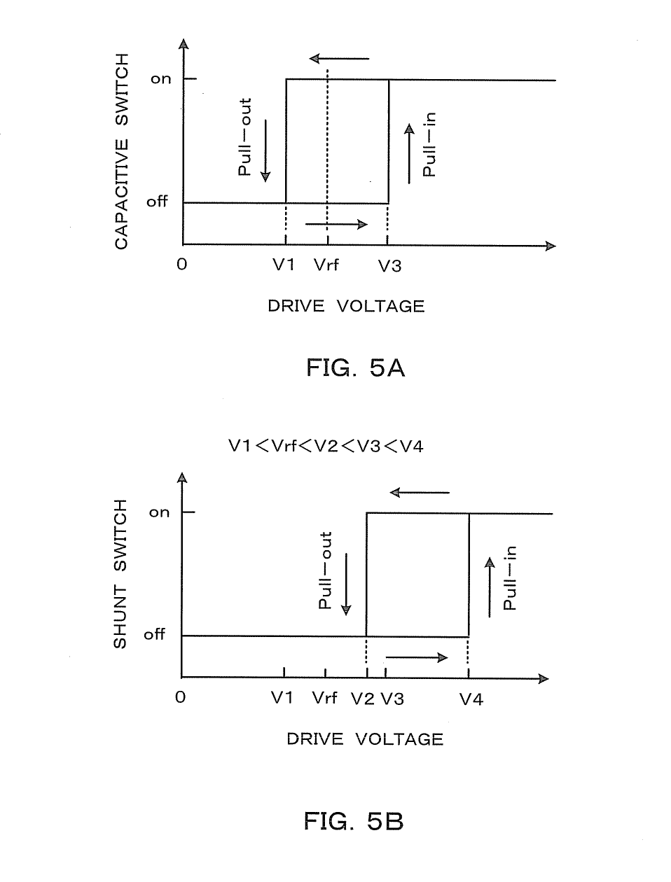

FIGS. 5A and 5B are graphs each illustrating an operational characteristic of the electrical component 10. Specifically, FIG. 5A is a graph showing the operational characteristic of the first electrical component 11. FIG. 5B is a graph showing the operational characteristic of the second electrical component 14.

As shown in FIGS. 5A and 5B, the operational characteristics of the variable capacitor 11 and the shunt switch 12 have a hysteresis characteristic of becoming the on-state when a drive voltage is equal to or larger than an a certain value (a pull-in voltage), and becoming the off-state when the drive voltage is equal to or smaller than a certain value (a pull-out voltage).

When the high frequency signal is passing through the variable capacitor 11 and the shunt switch 12, electrostatic attraction Fe is generated by the high frequency signal and is expressed by the following equations:

$$\begin{matrix}Vsw = √ ( 2 PZ 0 ) sin ( ω t ) & ( 1 ) \\ \begin{matrix}Fe = - ɛ0 {AVsw}^{2} / ( 2 {g}^{2} ) \\ = - ɛ0 A ( 2 PZ 0 ) {sin}^{2} ( ω t ) / ( 2 {g}^{2} ) \\ = - ɛ0 A ( PZ 0 ) ( 1 + sin ( 2 ω t ) ) / ( 2 {g}^{2} ) \\ \approx - ɛ0 {A ( √ ( PZ 0 ) )}^{2} / ( 2 {g}^{2} )\end{matrix} & ( 2 )\end{matrix}$$

where Vsw is a high frequency signal, P is power of the high frequency signal, Z0 is a characteristic impedance, A is an electrode area, and g is a gap between the electrodes.

The first and second actuator portions 25, 43 have a resonance frequency sufficiently lower than the frequency of the high frequency signal, and do not respond to the high frequency signal. Thus, sin(2ωt) in the equation 2 does not exceed zero. As a result, a DC bias voltage Vrf equivalent to √(PZO) is generated in the drive electrode 28 of the variable capacitor 11 and the drive electrode 46 of the shunt switch 12.

In the variable capacitor 11, the first actuator portion 25 is designed to have low stiffness so that the variable capacitor 11 has a pull-out voltage V1 lower than the bias voltage Vrf and a pull-in voltage V3 higher than the bias voltage Vrf.

On the other hand, in the shunt switch 12, the second actuator portion 43 is designed to have high stiffness so that the shunt switch 12 has a pull-out voltage V2 higher than the bias voltage Vrf and a pull-in voltage V4 higher than the bias voltage Vrf.

With the configuration described above, the variable capacitor 11 cannot be switched off when the high frequency signal is passing through the variable capacitor 11 in the on-state even if the drive voltage is set equal to or lower than the pull-out voltage V1. Here, the pull-in voltage V3 can be lowered. Thus, power to maintain the on-state of the variable capacitor 11 is reduced.

The power required to maintain the on-state means power to be consumed by the drive electrode as well as power to be consumed by a drive circuit including, for example, a booster circuit to increase a power source voltage to a drive voltage.

On the other hand, the shunt switch 12 can be switched off without any problem by setting the drive voltage to be equal to or lower than the pull-out voltage V2 when the high frequency signal is passing through the shunt switch 12 in the on-state. Here, the pull-in voltage V4 is increased, which results in an increase of the power required to maintain the on-state.

However, a period during which the shunt switch 12 maintains the on-state is far shorter than a period during which the variable capacitor 11 maintains the on-state. Thus, the power consumption can be reduced as a whole.

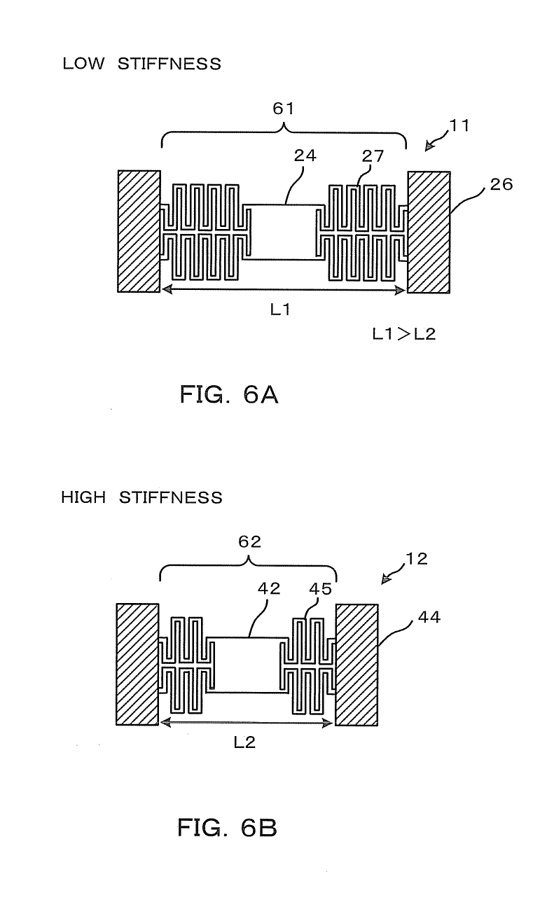

FIGS. 6A and 6B are views each illustrating stiffness of the electrical component 10. Specifically, FIG. 6A is a plan view showing the stiffness of the variable capacitor 11. FIG. 6B is a plan view showing the stiffness of the shunt switch 12.

As shown in FIGS. 6A and 6B, the variable capacitor 11 has a bridge 61 which includes the second electrode 24, an unillustrated insulating material 29, and a zigzag-shaped (a meander structure) arm portions 27 and which has a length of L1. The shunt switch 12 has a bridge 62 which is made of the same material as the variable capacitor 11 and has thickness and width same as those of the variable capacitor 11. The bridge 62 includes the fourth electrode 42, an unillustrated insulating material 47, and arm portions 45 with the meander structure, and has a length of L2 which is shorter than the length L1.

A longer bridge tends to be more easily bent. For this reason, the first actuator portion 25 of the variable capacitor 11 having the bridge 61 with the length L1 has lower stiffness, while the second actuator portion 43 of the shunt switch 12 having the bridge 62 with the length L2 shorter than the length L1 has higher stiffness.

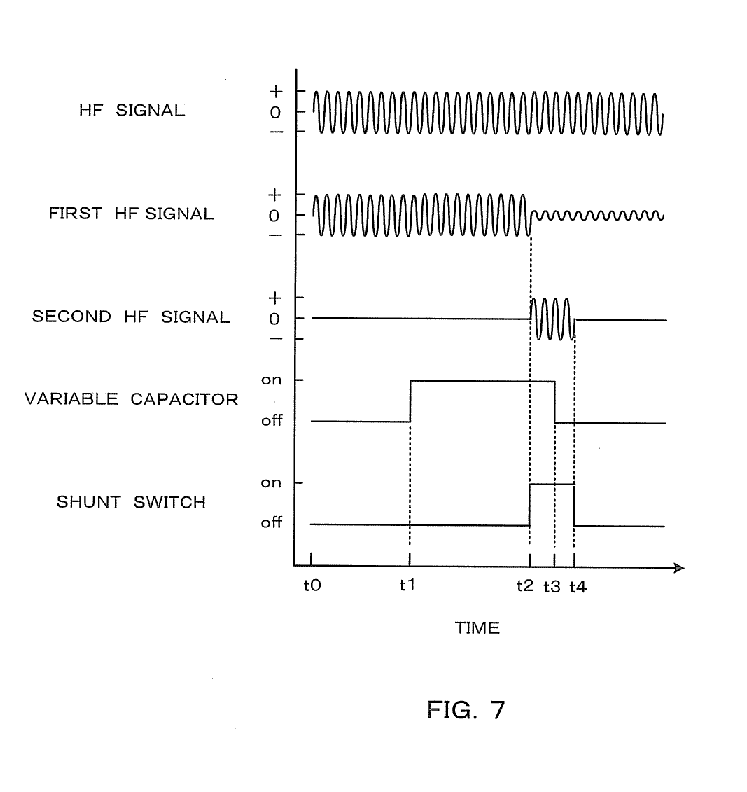

FIG. 7 is a timing chart showing the operation of the electrical component 10. The timing chart shows the case where the hot-switching is performed to cut the high frequency signal by switching off the variable capacitor 11 when the variable capacitor 11 is in the on-state and the high frequency signal is passing through the variable capacitor 11.

In FIG. 7, the first high frequency signal shows a high frequency signal to be inputted to the variable capacitor 11, while the second high frequency signal shows a high frequency signal to be inputted to the shunt switch 12. As shown in FIG. 7, the high frequency signal is inputted to the variable capacitor 11 regardless of the operational state of the variable capacitor 11 between time t0 and time t2 during which the shunt switch 12 is in the off-state.

After that, when the shunt switch 12 is switched on at time t2, the high frequency signal is bypassed to the shunt circuit 14 having a lower impedance. Accordingly, the high frequency signal passing through the variable capacitor 11 is cut and the high frequency signal passes through the shunt switch 12.

Subsequently, at time 3, the variable capacitor 11 through which the high frequency signal is not passing is easily switched off when the pull-out voltage V1 lower than the bias voltage Vrf is applied thereto.

After that, at time 4, the shunt switch 12 through which the high frequency signal is passing is switched off when the pull-out voltage V2 higher than the bias voltage Vrf is applied thereto. As a result, the high frequency signal passing through the shunt switch 12 is cut.

In other words, the shunt switch 12 is switched on at time t2 to bypass the high frequency signal to the shunt circuit 14, and then the variable capacitor 11 through which the high frequency signal is not passing is switched from the on-state to the off-state at time t3. Subsequently, the shunt switch 12 through which the high frequency signal is passing is switched from the on-state to the off-state at time t4.

As described above, the electrical component 10 of the embodiment includes the variable capacitor 11 and the shunt circuit 14 which is connected in parallel with the variable capacitor 11 and has the shunt switch 12 and the capacitor 13 which are connected in series. In the electrical component 10, the shunt switch 12 is switched on to bypass the high frequency signal to the shunt circuit 14, and then the variable capacitor 11 is switched from the on-state to the off-state.

As a result, the pull-out voltage V1 of the variable capacitor 11 can be made lower than the bias voltage Vrf. Accordingly, the power required to maintain the on-state of the variable capacitor 11 can be reduced. Thus, the electrical component 10 capable of performing hot switching at low power consumption can be obtained.

Furthermore, the pull-out voltage V4 of the variable capacitor 11 is lowered, so that charging to the insulating film 23 is reduced. Consequently, the reliability of the variable capacitor 11 is hardly deteriorated.

In the embodiment, the description is given of the case where the first electrical component is the variable capacitor 11. However, when a condition that the impedance of the first electrical component is sufficiently lower than the impedance Z2 of the shunt circuit 14 in the off-state is fulfilled, the first electrical component may be a switch.

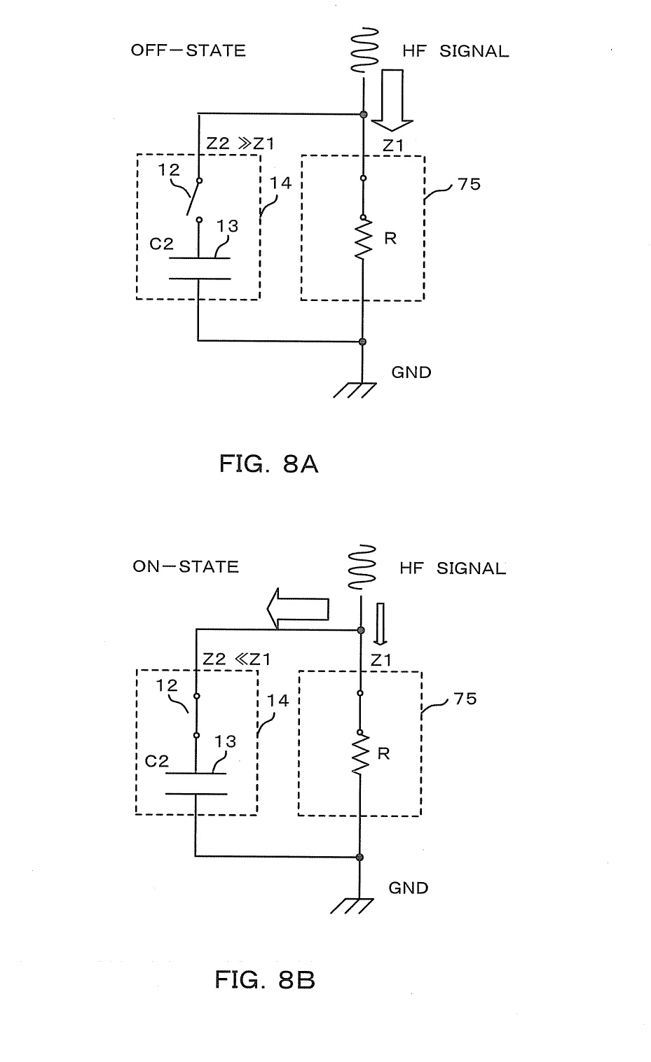

FIGS. 8A and 8B are views each showing an equivalent circuit of another electrical component. Specifically, FIG. 8A is an equivalent circuit when the second electrical component is in the off-state. FIG. 8B is an equivalent circuit when the second electrical component is in the on-state.

As shown in FIGS. 8A and 8B, when the first electrical component is a switch 75, the switch 75 has an impedance sufficiently lower than the impedance Z2 of the shunt circuit 14 in the off-state. Thereby, effects similar to the case of using the variable capacitor can be obtained.

### Second Embodiment

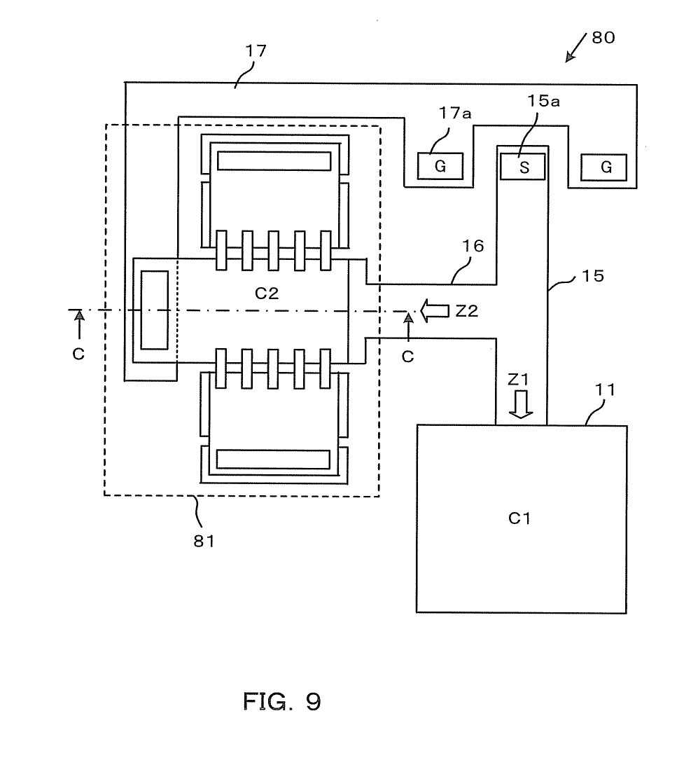

A second embodiment of the invention will be described with reference to FIGS. 9 to 11B.

In the embodiment, same reference numerals are given to denote component portions same as those of the first embodiment, and the descriptions thereof are omitted. Only different portions are described in the embodiment. The embodiment is different from the first embodiment in that a variable capacitor is set as a second electrical component.

In other words, as shown in FIG. 9, an electrical component 80 of the embodiment includes a variable capacitor 81 as a second electrical component.

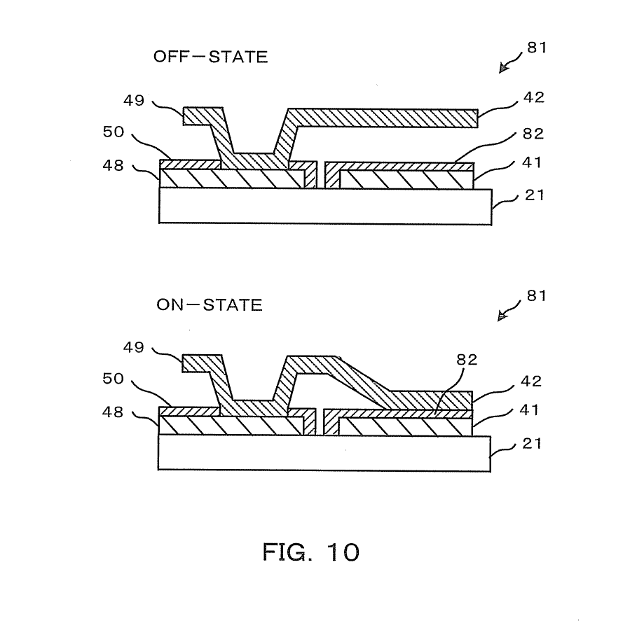

FIG. 10 is a view showing the electrical component 80. Specifically, FIG. 10 is a cross-sectional view taken along the C-C line of FIG. 9 as seen in a direction of an arrow. As shown in FIG. 10, the variable capacitor 81 has a lower electrode 48 and an upper electrode 49 which are in direct contact with each other to be conductive, and has an insulating film 82 formed on a third electrode 41. When the variable capacitor 81 is in an on-state, the third electrode 41 and a fourth electrode 42 come into close contact with each other with the insulating film 82 in between.

A capacity C2 of the variable capacitor 81 is required to be sufficiently larger than a capacity C1 of the variable capacitor 11. Basically, an area of the fourth electrode 42 of the variable capacitor 81 is set to have an area same as that of the upper electrode 49 of the capacitor 13 so that the capacity C2 of the variable capacitor 81 would be equal to a capacity C2 of the capacitor 13.

For this reason, the fourth electrode 42 of the variable capacitor 81 is heavier than the fourth electrode 42 of the shunt switch 12. Thus, it is preferable that the stiffness of a second actuator portion 43 of the variable, capacitor 81 be higher than the stiffness of a second actuator portion 43 of the shunt switch 12.

When the stiffness of the second actuator portion 43 of the variable capacitor 81 is increased, a pull-in voltage V4 is also increased. However, as described above, a period during which the second actuator portion 43 is maintained in the on-state is extremely short. Thus, an increase of power consumption is very small, which has almost no effect.

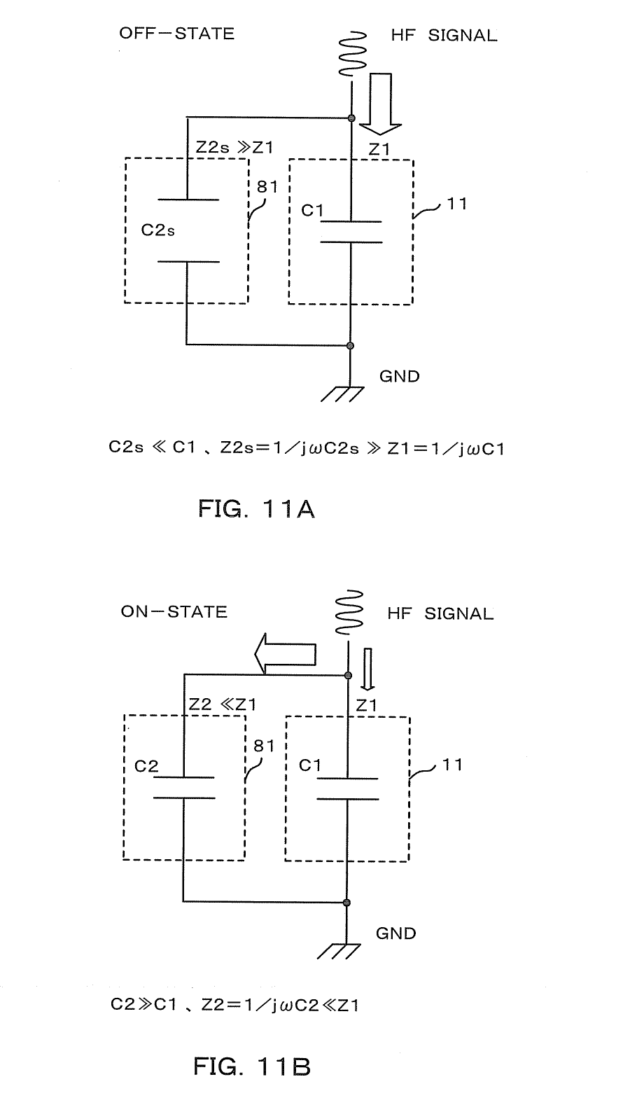

FIGS. 11A and 11B are views each showing an equivalent circuit of the electrical component 80. Specifically, FIG. 11A is an equivalent circuit when the variable capacitor 81 is in the off-state. FIG. 11B is an equivalent circuit when the variable capacitor 81 is in the on-state.

As shown in FIGS. 11A and 11B, when the variable capacitor 81 is in the off-state, a capacity C2s of the variable capacitor 81 is sufficiently smaller than the capacity C1 of the variable capacitor 11. Thus, an impedance Z2 of the variable capacitor 81 becomes sufficiently larger than the impedance Z1 of the variable capacitor 11. As a result, a high frequency signal passes through the variable capacitor 11.

When the variable capacitor 81 is in the on-state, the capacity C2 of the variable capacitor 81 is sufficiently larger than the capacity C1 of the variable capacitor 11. Thus, the impedance Z2 of the variable capacitor 81 becomes sufficiently smaller than the impedance Z1 of the variable capacitor 11. As a result, the high frequency signal is bypassed from the variable capacitor 11 to the variable capacitor 81.

As described above, the electrical component 80 of the embodiment includes the variable capacitor 81 as the second electrical component. Accordingly, there is an advantage that the variable capacitor 81 can be manufactured in the same process of manufacturing the variable capacitor 11 as the first electrical component.

In the above-described embodiments, the description is given of the case where the first actuator portion 25 and the second actuator portion 43 are bridge-shaped actuators. However, the actuator portions may be cantilever actuator portions. In this case, there is an advantage that each of the first actuator portion 25 and the second actuator portion 43 is required to be provided only on one side.

Specifically, the first actuator portion includes a third conductive leg portion, a third conductive arm portion, and a third drive electrode. The third leg portion is provided on one side of the first electrode 22 so as to be spaced apart from the first electrode 22 and is set upright from a main surface of a substrate 21. The third arm portion extends from an upper end of the third leg portion in a direction parallel with the substrate 21 to a position where a tip end of the third arm portion is short of the first electrode 22. The third drive electrode is formed on the main surface of the substrate 21 between the first electrode 22 and the third leg portion.

Similarly, the second actuator portion includes a fourth conductive leg portion, a fourth conductive arm portion, and a fourth drive electrode. The fourth leg portion is provided on one side of the third electrode 41 so as to be spaced apart from the third electrode 41 and is set upright from the main surface of the substrate 21. The fourth arm portion extends from an upper end of the fourth leg portion in a direction parallel with the substrate 21 to a position where a tip end of the fourth arm portion is short of the third electrode 41. The fourth drive electrode is formed on the main surface of the substrate 21 between the third electrode 41 and the fourth leg portion.

The description is given of the case where the variable capacitors 11, 81 and the switch 12 are electrostatically-driven variable capacitors. However, piezoelectrically-actuated variable capacitors may be used. In this case, the first actuator portion 25 and the second actuator portion 43 are set to be piezoelectric actuators including an arm portion having a piezoelectric film being held between a pair of electrode films.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An electrical component comprising:
a first electrical component including a first electrode and a second electrode facing the first electrode with a space in between, the second electrode being moved by a first actuator portion; and
a second electrical component being connected in parallel to the first electrical component and including a third electrode and a fourth electrode facing the third electrode with a space in between, the fourth electrode being moved by a second actuator portion having a stiffness higher than a stiffness of the first actuator portion, the second electrical component having an impedance becoming higher or lower than an impedance of the first electrical component depending on a moving state of the fourth electrode.

2. The electrical component according to claim 1, wherein the impedance of the second electrical component when the driving of the second actuator portion is stopped and the third electrode and the fourth electrode are spaced apart from each other is higher than the impedance of the first electrical component when the first actuator portion is driven and the first electrode and second electrode are substantially in contact with each other.

3. The electrical component according to claim 1, wherein the impedance of the second electrical component when the second actuator portion is driven and the third electrode and the fourth electrode are substantially in contact with each other is lower than the impedance of the first electrical component when the first actuator portion is driven and the first electrode and the second electrode are substantially in contact with each other.

4. The electrical component according to claim 1, wherein a relationship of V1<Vrf<V3 is established, where Vrf is a bias voltage generated in the first actuator portion when a high frequency signal is passing through the first electrical component, V1 is a pull-out voltage when the driving of the first actuator portion is stopped to space the first electrode and the second electrode apart from each other, and V3 is a pull-in voltage when the first actuator portion is driven to bring the first electrode and the second electrode substantially into contact with each other.

5. The electrical component according to claim 1, wherein a relationship of Vrf<V2<V4 is established, where Vrf is a bias voltage generated in the second actuator portion when a high frequency signal is passing through the second electrical component, V2 is a pull-out voltage when the driving of the second actuator portion is stopped to space the third electrode and the fourth electrode apart from each other, and V4 is a pull-in voltage when the second actuator portion is driven to bring the third electrode and the fourth electrode substantially into contact with each other.

6. The electrical component according to claim 1, wherein a relationship of V1<V2<V3<V4 is established, where V1 is a pull-out voltage when the driving of the first actuator portion is stopped to space the first electrode and the second electrode apart from each other, V2 is a pull-out voltage when the driving of the second actuator portion is stopped to space the third electrode and the fourth electrode apart from each other, V3 is a pull-in voltage when the first actuator portion is driven to bring the first electrode and the second electrode substantially into contact with each other, and V4 is a pull-in voltage when the second actuator portion is driven to bring the third electrode and the fourth electrode substantially into contact with each other.

7. The electrical component according to claim 1, wherein, when the first electrical component is on with the first actuator portion driven to cause the first electrode and the second electrode to be substantially in contact with each other, the first and second actuator portions are driven in such a manner that:
the second actuator portion is driven to bring the third electrode and the fourth electrode substantially into contact with each other, so that the second electrical component is switched on; thereafter,
the driving of the first actuator portion is stopped to space the first electrode and the second electrode apart from each other, so that the first electrical component is switched off; and then,
the driving of the second actuator portion is stopped to space the third electrode and the fourth electrode apart from each other, so that the second electrical component is switched off.

8. The electrical component according to claim 1, wherein
the first electrical component is any one of a variable capacitor in which the first electrode and the second electrode come into contact with each other with a dielectric film in between, and a switch in which the first electrode and the second electrode come in direct contact with each other, and
the second electrical component is any one of a variable capacitor in which the third electrode and the fourth electrode come into contact with each other with a dielectric film in between and a series circuit including a capacitor and a switch in which the third electrode and the fourth electrode come into direct contact with each other.

9. The electrical component according to claim 1, wherein
, in the first electrical component,
the first electrode is formed on a main surface of a substrate,
the first actuator portion includes: a pair of first conductive leg portions provided on both sides of the first electrode so as to be spaced apart from the first electrode and set upright from the main surface of the substrate; a pair of first conductive arm portions extending from upper ends of the pair of the first leg portions, respectively, in a direction parallel with the substrate and having tip ends facing each other with a space in between;
and a pair of first drive electrodes formed on the main surface of the substrate respectively at positions each between the first electrode and a corresponding one of the pair of the first leg portions, and
the second electrode is connected to the tip ends of the pair of the first arm portions directly or with an insulating material in between, and
, in the second electrical component,
the third electrode is formed on the main surface of the substrate,
the second actuator portion includes: a pair of second conductive leg portions provided on both sides of the third electrode so as to be spaced apart from the third electrode and set upright from the main surface of the substrate; a pair of second conductive arm portions extending from upper ends of the pair of the second leg portions, respectively, in a direction parallel with the substrate and having tip ends facing each other with a space in between; and a pair of second drive electrodes formed on the main surface of the substrate respectively at positions each between the third electrode and a corresponding one of the pair of the second leg portions, and
the fourth electrode is connected to the tip ends of the pair of the second arm portions directly or with an insulating material in between.

10. The electrical component according to claim 9, wherein the first arm portions and the second arm portions have a meander structure in which each of the first arm portions and the second arm portions extends while being alternately folded in the opposite directions.

11. The electrical component according to claim 1, wherein
the first actuator portion includes: a third conductive leg portion provided on one side of the first electrode so as to be spaced apart from the first electrode and set upright from the main surface of the substrate; a third conductive arm portion extending from upper end of the third leg portion in a direction parallel with the substrate and having tip end locating in front of the first electrode; and a third drive electrode formed on the main surface of the substrate at a position between the first electrode and the third leg portion, and
the second actuator portion includes: a fourth conductive leg portion provided on one side of the third electrode so as to be spaced apart from the third electrode and set upright from the main surface of the substrate; a fourth conductive arm portion extending from upper end of the fourth leg portion in a direction parallel with the substrate and having tip end locating in front of the third electrode; and a fourth drive electrode formed on the main surface of the substrate at a position between the third electrode and the fourth leg portion.

12. The electrical component according to claim 1, wherein each of the first actuator portion and the second actuator portion is a piezoelectric actuator including an arm portion having a piezoelectric film being held between a pair of electrode films.

13. An electrical component comprising:
a first electrical component including a first electrode and a second electrode facing the first electrode with a space in between, the second electrode being moved by a first actuator portion; and
a second electrical component being connected in parallel to the first electrical component and including a third electrode and a fourth electrode facing the third electrode with a space in between, the fourth electrode being moved by a second actuator portion having a stiffness higher than a stiffness of the first actuator portion, the second electrical component having an impedance becoming higher or lower than an impedance of the first electrical component depending on a moving state of the fourth electrode,
wherein, in the first electrical component,
the first electrode is formed on a main surface of a substrate,
the first actuator portion includes: a pair of first conductive leg portions provided on both sides of the first electrode so as to be spaced apart from the first electrode and set upright from the main surface of the substrate; a pair of first conductive arm portions extending from upper ends of the pair of the first leg portions, respectively, in a direction parallel with the substrate and having tip ends facing each other with a space in between; and a pair of first drive electrodes formed on the main surface of the substrate respectively at positions each between the first electrode and a corresponding one of the pair of the first leg portions, and
the second electrode is connected to the tip ends of the pair of the first arm portions directly or with an insulating material in between, and
wherein, in the second electrical component,
the third electrode is formed on the main surface of the substrate,
the second actuator portion includes: a pair of second conductive leg portions provided on both sides of the third electrode so as to be spaced apart from the third electrode and set upright from the main surface of the substrate; a pair of second conductive arm portions extending from upper ends of the pair of the second leg portions, respectively, in a direction parallel with the substrate and having tip ends facing each other with a space in between; and a pair of second drive electrodes formed on the main surface of the substrate respectively at positions each between the third electrode and a corresponding one of the pair of the second leg portions, and
the fourth electrode is connected to the tip ends of the pair of the second arm portions directly or with an insulating material in between.

14. The electrical component according to claim 13, wherein the impedance of the second electrical component when the driving of the second actuator portion is stopped and the third electrode and the fourth electrode are spaced apart from each other is higher than the impedance of the first electrical component when the first actuator portion is driven and the first electrode and second electrode are substantially in contact with each other.

15. The electrical component according to claim 13, wherein the impedance of the second electrical component when the second actuator portion is driven and the third electrode and the fourth electrode are substantially in contact with each other is lower than the impedance of the first electrical component when the first actuator portion is driven and the first electrode and the second electrode are substantially in contact with each other.

16. The electrical component according to claim 13, wherein a relationship of V1<Vrf<V3 is established, where Vrf is a bias voltage generated in the first actuator portion when a high frequency signal is passing through the first electrical component, V1 is a pull-out voltage when the driving of the first actuator portion is stopped to space the first electrode and the second electrode apart from each other, and V3 is a pull-in voltage when the first actuator portion is driven to bring the first electrode and the second electrode substantially into contact with each other.

17. The electrical component according to claim 13, wherein a relationship of Vrf<V2<V4 is established, where Vrf is a bias voltage generated in the second actuator portion when a high frequency signal is passing through the second electrical component, V2 is a pull-out voltage when the driving of the second actuator portion is stopped to space the third electrode and the fourth electrode apart from each other, and V4 is a pull-in voltage when the second actuator portion is driven to bring the third electrode and the fourth electrode substantially into contact with each other.

18. The electrical component according to claim 13, wherein a relationship of V1<V2<V3<V4 is established, where V1 is a pull-out voltage when the driving of the first actuator portion is stopped to space the first electrode and the second electrode apart from each other, V2 is a pull-out voltage when the driving of the second actuator portion is stopped to space the third electrode and the fourth electrode apart from each other, V3 is a pull-in voltage when the first actuator portion is driven to bring the first electrode and the second electrode substantially into contact with each other, and V4 is a pull-in voltage when the second actuator portion is driven to bring the third electrode and the fourth electrode substantially into contact with each other.

19. The electrical component according to claim 13, wherein, when the first electrical component is on with the first actuator portion driven to cause the first electrode and the second electrode to be substantially in contact with each other, the first and second actuator portions are driven in such a manner that:
the second actuator portion is driven to bring the third electrode and the fourth electrode substantially into contact with each other, so that the second electrical component is switched on; thereafter,
the driving of the first actuator portion is stopped to space the first electrode and the second electrode apart from each other, so that the first electrical component is switched off; and then,
the driving of the second actuator portion is stopped to space the third electrode and the fourth electrode apart from each other, so that the second electrical component is switched off.

20. The electrical component according to claim 13, wherein
the first electrical component is any one of a variable capacitor in which the first electrode and the second electrode come into contact with each other with a dielectric film in between, and a switch in which the first electrode and the second electrode come in direct contact with each other, and
the second electrical component is any one of a variable capacitor in which the third electrode and the fourth electrode come into contact with each other with a dielectric film in between and a series circuit including a capacitor and a switch in which the third electrode and the fourth electrode come into direct contact with each other.
